(19) United States
(12) Patent Application Publication
(10) Pub. No.: US 2023/0130904 A1
(43) Pub. Date: Apr. 27, 2023

(54) Hula hoop unit sections and a hula hoop

(71) Applicant: Xiaoqiang LU, Zhejiang (CN)

(72) Inventor: Xiaoqiang LU, Zhejiang (CN)

(21) Appl. No.: 17/585,464

(22) Filed: Jan. 26, 2022

(30) Foreign Application Priority Data
Oct. 21, 2021 (CN) 202111225573.0
Oct. 21, 2021 (CN) 202122545461.5
Oct. 21, 2021 (CN) 202122545465.3

(51) Int. Cl. A63B 19/00; A61H 7/00

(52) U.S. Cl. CPC A63B 19/00; A61H 7/002; A61H 2201/0107

(57) ABSTRACT

Hula hoop unit sections and a hula hoop formed by the unit sections, wherein each unit section has one end having an inserting groove with a side opening, and another end having a plugging part capable of inserting the side opening into the inserting groove of an adjacent unit section. Each unit section also has a switching mechanism to open or close the side opening thereof so that the plugging part is maintained in or released from the inserting groove respectively. When two adjacent unit sections are subject to circumferential pulling force, the plugging part of one unit section can still be stably maintained inside the inserting groove; even if two adjacent unit sections are subject to lateral force, the plugging part is still maintained inside the inserting groove due to blocking effect by the switching mechanism, thereby ensuring a stable connection between the two adjacent unit sections.

### BACKGROUND OF THE INVENTION

The present invention relates to a hula hoop and more particularly a smart weighted hula hoop that is tied around a user's waist and does not fall off from the user's waist during exercise.

A Chinese patent CN111202942A has disclosed a hula hoop, comprising a hoop body, wherein the hoop body is formed by connecting a plurality of unit sections end to end; every two adjacent unit sections are detachably connected with each other through a connecting piece; each unit section is provided with a containing groove for a corresponding connecting piece to be inserted; a front section and a rear section of the connecting piece are respectively inserted into the containing grooves of the two adjacent unit sections respectively; each unit section is provided with a locking mechanism to maintain the corresponding connecting piece inside the corresponding containing groove; the locking mechanism comprises an operating button and a spring; the operating button is configured to be slidable in and out of the unit section between a locking position and a releasing position; the spring is arranged between the operating button and the unit section to drive the operating button to reset to the locking position; the operating button is provided with a first limiting part; the connecting piece is provided with a second limiting part, and an inclined guiding slope is formed on the front side of the first limiting part; the second limiting part can be guided to the rear side of the first limiting part by the guiding inclined surface; the connecting piece is inserted into the containing groove along an end of the unit section; two adjacent unit sections are mainly affected by their circumferential forces, and thus the connecting pieces are easy to directly fall out of the containing grooves when the locking mechanisms are damaged, causing the unit sections to separate and fall.

### BRIEF SUMMARY OF THE INVENTION

It is an object of the present invention to provide hula hoop unit sections which can be conveniently assembled and disassembled and can be stably connected with one another.

The object of the present invention is achieved by the technical solutions as follows:

Hula hoop unit sections, wherein one end of each unit section is provided with an inserting groove with a side opening, and another end of each unit section is provided with a plugging part capable of inserting into the inserting groove of an adjacent unit section through the side opening of the adjacent unit section; each unit section also comprises a switching mechanism capable of opening or closing the side opening thereof, so that two adjacent unit sections are detachably connected through the plugging part of one of said two adjacent unit sections and the inserting groove of another one of said two adjacent unit sections, in other words, the plugging part of one of said two adjacent unit sections is inserted into the inserting groove of another one of said two adjacent unit sections through the side opening of said another one of said two adjacent unit sections; the plugging part of one of said two adjacent unit sections inserts into the side opening of the inserting groove of another one of said two adjacent unit sections, and being maintained inside the inserting groove of said another one of said two adjacent unit sections through the switching mechanism of said another one of said two adjacent unit sections; when the two adjacent unit sections are subject to circumferential pulling force, the plugging part of said one of said two adjacent unit sections can still be stably maintained inside the inserting groove of said another one of said two adjacent unit sections; even if two adjacent unit sections are subject to lateral force, the plugging part of said one of said two adjacent unit sections can still be maintained inside the inserting groove of said another one of said two adjacent unit sections due to the blocking effect by the switching mechanism of said another one of said two adjacent unit sections, thereby ensuring a stable connection between the two adjacent unit sections.

The switching mechanism of each unit section comprises a sliding block and a resilient piece; the sliding block is movably provided on the unit section between a close position and an open position; when the sliding block is positioned at the close position, the sliding block blocks the side opening of the inserting groove; when the sliding block is positioned at the open position, the sliding block opens the side opening of the inserting groove; the resilient piece drives the sliding block to bias against the close position. During operation, push the sliding block of said another one of said two adjacent unit sections so that the sliding block slides to the open position, and then the plugging part of said one of said two adjacent unit sections is inserted into or withdrawn from the inserting groove of said another one of the two adjacent unit sections via the side opening of said another one of the two adjacent unit sections. When the plugging part of said one of the two adjacent unit sections is inserted into the inserting groove of said another one of the two adjacent unit sections, release the sliding block of said another one of the two adjacent unit sections so that the sliding block automatically resets to the close position under the resilient force of the resilient piece to block the side opening of the inserting groove, and as such, the plugging part of said one of the two adjacent unit sections cannot be pulled out. The present invention enables convenient operation according to which two adjacent unit sections can be detached from each other even by using only one single hand when it is desired to open up the hoop body of the hula hoop.

Each unit section is provided with sliding grooves extending along a sliding direction of the sliding block; the sliding block is provided with protruding ribs slidably disposed in the sliding grooves respectively; cooperative relationship between the sliding grooves and the protruding ribs can guide the sliding block to slide smoothly and correctly, and can limit the sliding stroke of the sliding block.

A top surface of the sliding block is provided with an upper protruding rib of the protruding ribs extending along a sliding direction of the sliding block; a bottom surface of the sliding block is provided with a lower protruding rib of the protruding ribs extending along the sliding direction of the sliding block; the sliding grooves comprise an upper sliding groove and a lower sliding groove corresponding to the upper protruding rib and the lower protruding rib respectively; the upper protruding rib and the lower protruding rib extend along the sliding direction of the sliding block and slidably disposed in the upper sliding groove and the lower sliding groove respectively; thereby strengthening the installation of the sliding block so that the sliding block of one unit section can withstand the lateral action force from the plugging part of the adjacent unit section without being damaged or falling off.

An outer side of the sliding block is provided with an operating portion; the operating portion facilitates the sliding movement of the sliding block.

The resilient piece is a coil spring.

One end of the sliding block is provided with a positioning rod that is inserted into the coil spring; use of the positioning rod facilitates positioning and installation of the coil spring.

The plugging part is connected with the unit section via a connecting board; said one end of each unit section is also provided with an end opening in communication with the inserting groove in order to accommodate the connecting board of an adjacent unit section. The connecting board guarantees reliable connection between the plugging part and the unit section. The end opening of the unit section provides a space to accommodate the connecting board of an adjacent unit section so that the plugging part of the adjacent unit section can be smoothly inserted into the inserting groove of the unit section.

The inserting groove of each unit section is provided with a positioning rib extending along an extending direction of the inserting groove which extends along a widthwise direction of the corresponding unit section; the plugging part of each unit section is provided with a positioning groove corresponding to the positioning rib of a respective adjacent unit section. Cooperation between the positioning rib and the positioning groove enables the plugging part of each unit section to be stably maintained inside the inserting groove of the respective adjacent unit section without any wobbling.

The widthwise direction of each unit section along which the inserting groove extends is perpendicular to a lengthwise direction of the corresponding unit section, alternatively, the widthwise direction of each unit section along which the inserting groove extends is not perpendicular to the lengthwise direction of the corresponding unit section. In the former configuration, insertion by the plugging part from a respective adjacent unit section into the inserting groove can be realized more easily and smoothly so that two adjacent unit sections can be connected more quickly and conveniently. In the latter configuration, the plugging part from a respective adjacent unit section is difficult to be pulled out from the side opening of the inserting groove, so that connection between two adjacent unit sections is more reliable.

Each unit section has an arc shape. An outer side surface of each unit section facing inwardly to the hula hoop configured after all unit sections are assembled, has two side edges each extending transversely with an arc-shaped blocking board, so that there are two arc-shaped blocking boards in each unit section; each arc-shaped blocking board has one end disposed with a protruding blocking portion, and another end disposed with an indented portion allowing insertion of another corresponding blocking portion from an adjacent unit section; in each unit section, when one end of one of the two arc-shaped blocking boards is provided with the blocking portion, an end of another one of the two arc-shaped blocking boards orienting towards a same direction as said one end of said one of the two arc-shaped blocking boards is provided with the indented portion; cooperative relationship between the blocking portion of any one of the arc-shaped blocking board of one of the two adjacent unit sections and the indented portion of a corresponding arc-shaped blocking board of another one of the two adjacent unit sections may conceal a gap between the two corresponding arc-shaped blocking boards of the two adjacent unit sections, and prevent clothes of the user from being clamped by the gap which may otherwise affect the use of the hula hoop.

Two sides of each unit section are each provided with an arc-shaped rail portion opposite to and spaced apart from a corresponding arc-shaped blocking board, so that each unit section has two arc-shaped rail portions; each arc-shaped rail portion is slidably cooperative with a corresponding wheel of a sliding base; a trough is defined between each arc-shaped rail portion and the corresponding arc-shaped blocking board so that the corresponding wheel of the sliding base is slidable therein.

An outer side edge of each arc-shaped blocking board is positioned more outwardly from the hula hoop than an outer side edge of the corresponding arc-shaped rail portion, so that the arc-shaped blocking board may conceal the corresponding wheel of the sliding base and prevent clothes of users from being dragged by the wheel.

Each unit section comprises an outer side piece, an inner side piece, and a middle piece arranged in between the outer side piece and the inner side piece; one end of the middle piece is connected with the plugging part; another end of the middle piece is provided with the inserting groove; the sliding block is slidable between the outer side piece and the middle piece; each unit section formed by assembling the outer side piece, the inner side piece and the middle piece facilitates product manufacturing and assembly.

A positioning inserting slot is formed on the middle piece extending along a lengthwise direction of the middle piece; a positioning inserting board inserted into the positioning inserting slot is formed on a bottom side of the outer side piece; coordination between the positioning inserting slot and the positioning inserting board achieves accurate and reliable installation of the middle piece.

The outer side piece and the inner side piece are in locked connection through first screws; two counterbores are formed towards an interior of the inner side piece for the first screws to pass through; the outer side piece and the middle piece are in locked connection through a second screw.

An elastic massage head is provided on an outer side of the inner side piece facing inwardly to the hula hoop configured after all unit sections are assembled; a mounting hole is formed on said outer side of the inner side piece to accommodate the elastic massage head; the second screw enters the unit section through the mounting hole before installing the elastic massage head to connect and lock the middle piece and the outer side piece together; the elastic massage head is provided with a limiting part fitted at an inner flange of the mounting hole, a massaging part configured out of the mounting hole, and a connecting part disposed between the massaging part and the limiting part to connect the massaging part and the limiting part; plug heads are formed on the massaging part inserting into two hollow counterbore bases of the counterbores respectively, so as to conceal the first screws and the second screw; when the unit section needs to be disassembled, just remove the elastic massage head to manipulate the first screws and the second screw; also, since the elastic massage head is made of elastic material, just press the limiting part into the mounting hole to be fitted with the inner flange of the mounting hole to assemble the elastic massage head to the unit section; by exerting a certain amount of pulling force, the limiting part can be pulled and detached from the mounting hole, thereby disassembling the elastic massage head conveniently.

A top side of the limiting part is provided with a deformable recess which is recessed downwardly to the connecting part; the deformable recess allows an increased degree of deformation of the limiting part, so that the limiting part can be more easily pressed into the mounting hole or detached from the mounting hole.

Two end surfaces of each unit section are each provided with a position limiting platform such that each position limiting platform is positioned between the unit section on which it is provided and a corresponding adjacent unit section, thereby providing a distance between the two adjacent unit sections so as to prevent the distance between the two adjacent unit sections becoming too small due to deformation of the hoop body of the hula hoop which may otherwise clamp the skin of the waist of the user.

A hula hoop, comprising a hoop body, a sliding base, and a counterweight piece; the sliding base is slidably arranged onto the hoop body; the counterweight piece is connected to the sliding base; wherein the hoop body is formed by connecting a plurality of unit sections end to end; each unit section has an arc-shape; every two adjacent unit sections are detachably connected via the plugging part of one of the two adjacent unit sections inserting into the inserting groove of another one of the two adjacent unit sections.

An outer side surface of each unit section facing inwardly to the hula hoop configured after all unit sections are connected, has two side edges each extending transversely with an arc-shaped blocking board, so that there are two arc-shaped blocking boards in each unit section; each arc-shaped blocking board has one end disposed with a protruding blocking portion, and another end disposed with an indented portion allowing insertion of another corresponding blocking portion from an adjacent unit section; in each unit section, when one end of one of the two arc-shaped blocking boards is provided with the blocking portion, an end of another one of the two arc-shaped blocking boards orienting towards a same direction as said one end of said one of the two arc-shaped blocking boards is provided with the indented portion; a gap exists between the blocking portion of any one of the arc-shaped blocking board of one of the two adjacent unit sections and the corresponding indented portion of a corresponding arc-shaped blocking board of another one of the two adjacent unit sections; cooperative relationship between the blocking portion of said any one of the arc-shaped blocking board of one of the two adjacent unit sections and the indented portion of the corresponding arc-shaped blocking board of said another one of the two adjacent unit sections conceals a gap between the two corresponding arc-shaped blocking boards of the two adjacent unit sections, and prevent clothes of the user from being clamped by the gap which may otherwise affect the use of the hula hoop; said gap between the blocking portion of said any one of the arc-shaped blocking board of one of the two adjacent unit sections and the corresponding indented portion of the corresponding arc-shaped blocking board of said another one of the two adjacent unit sections provides a space for deformation between the two adjacent unit sections to accommodate different internal diameters of the hoop body.

A length of each blocking portion is 3 to 8 mm. The blocking portion having the length in said range may accommodate different internal diameters of the hoop body, thereby ensuring reliability of the blocking effect.

### BRIEF DESCRIPTION OF THE DRAWINGS

The present invention is further described in detail below with reference to the drawings.

FIG. 1 shows a perspective view of the hula hoop.

FIG. 2 shows a perspective view of the unit section, wherein the sliding block is in a close position.

FIG. 3 shows a perspective view of the unit section, wherein the sliding block is in an open position.

FIG. 4 shows an exploded view of the unit section.

FIG. 5 shows a bottom perspective view of the outer side piece.

FIG. 6 shows a perspective view of the sliding block.

FIG. 7 shows a perspective view of two adjacent unit sections in a connected state.

FIG. 8 shows a sectional view of two adjacent unit sections in a connected state.

FIG. 9 shows a bottom perspective view of the middle piece.

FIG. 10 is a top perspective view showing a cooperative relationship between the unit section and the sliding base.

FIG. 11 is a bottom perspective view showing a cooperative relationship between the unit section and the sliding base.

### DETAILED DESCRIPTION OF THE INVENTION

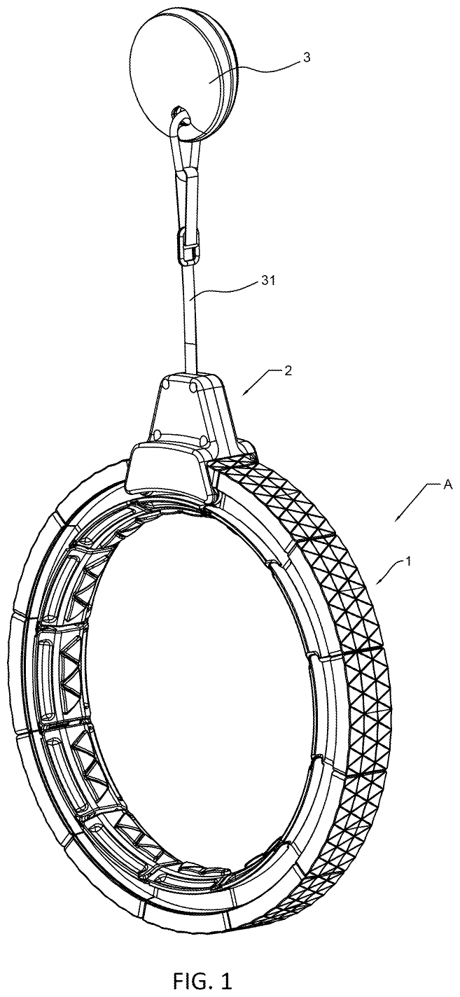

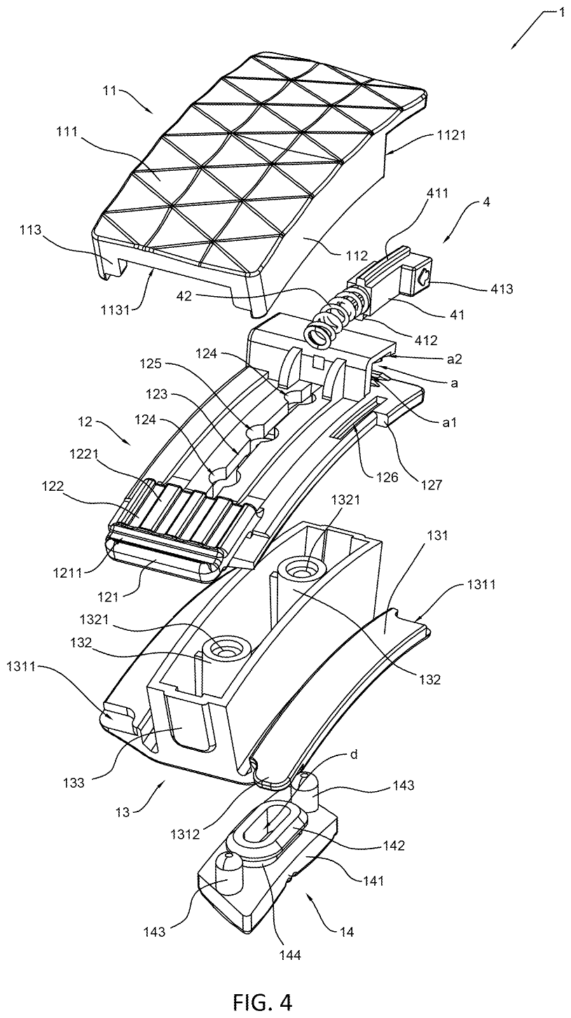

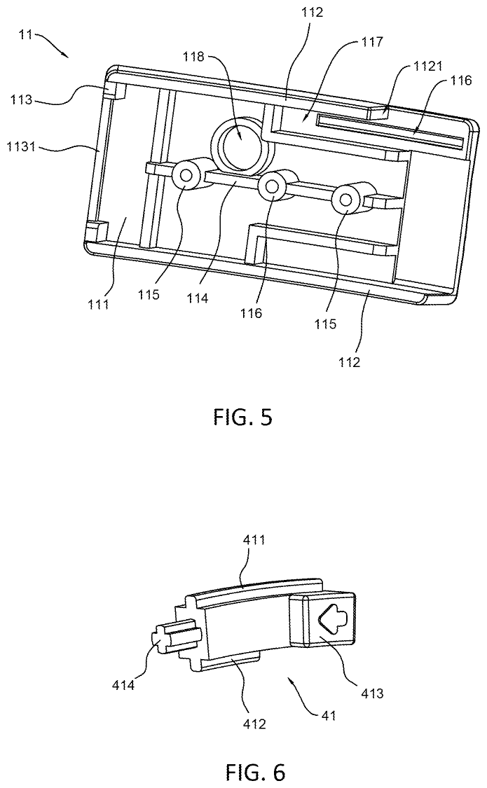

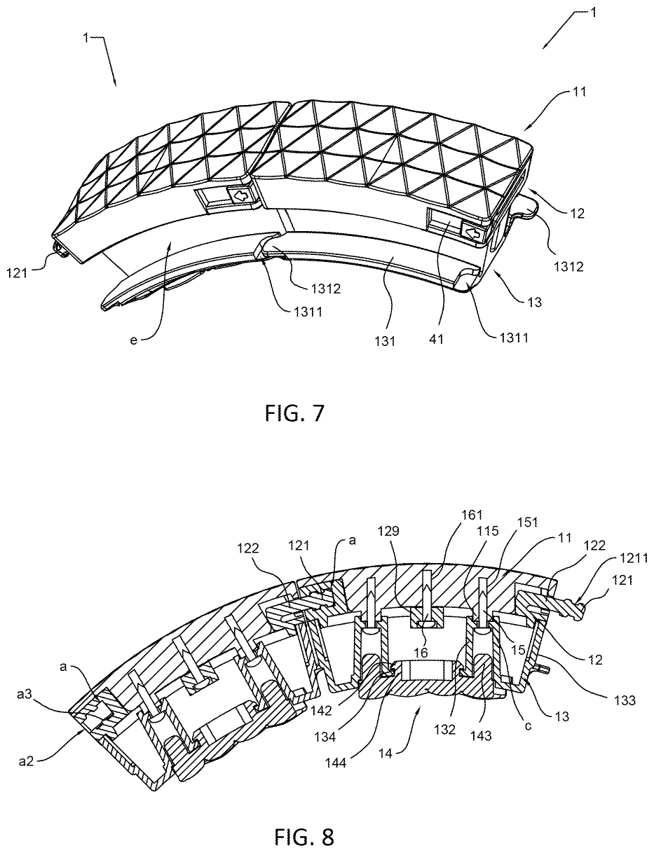

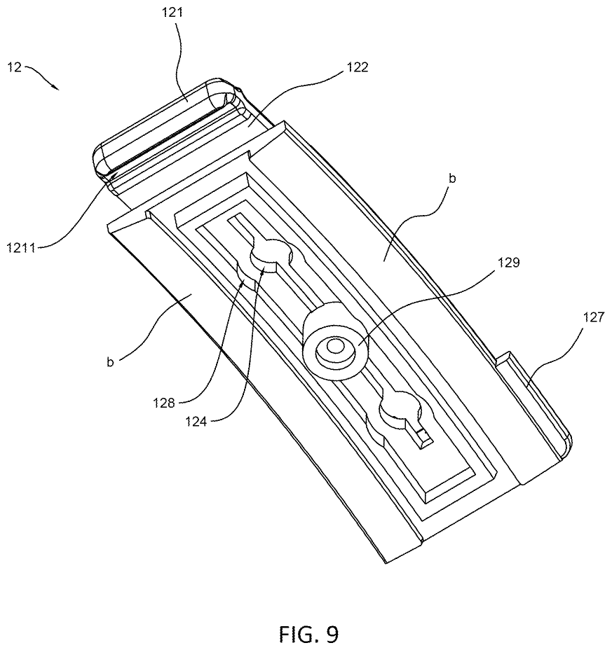

As illustrated in FIGS. 1-11, a hula hoop, comprising a hoop body (A), a sliding base (2), and a counterweight piece (3); the sliding base (2) is slidably arranged onto the hoop body (A); the counterweight piece (3) is connected to the sliding base (2) through a connecting rope (31).

The hoop body (A) is formed by connecting a plurality of unit sections (1) end to end; each unit section (1) is in an arc-shaped structure; an inserting groove (a) with a side opening (a1) is arranged on a first end of each unit section (1), and a plugging part (121) which can be inserted into the inserting groove (a) of an adjacent unit section through the side opening (a1) the adjacent unit section is arranged on a second end of each unit section (1); a switching mechanism (4) is arranged on each unit section (1) to maintain the plugging part (121) inside the inserting groove (a); the inserting groove (a) extends along a width direction of the unit section (1), so that two adjacent unit sections (1) are detachably connected through the plugging part (121) of one of said two adjacent unit sections (1) and the inserting groove (a) of another one of said two adjacent unit sections (1), in other words, the plugging part (121) of one of said two adjacent unit sections (1) is inserted into the inserting groove (a) of another one of said two unit sections (1) through the side opening (a1) of said another one of said two unit sections (1); the plugging part (121) of one of said two adjacent unit sections (1) inserts into the side opening (a1) of the inserting groove (a) of another one of said two adjacent unit sections (1), and being maintained inside the inserting groove (a) of said another one of said two adjacent unit sections (1) through the switching mechanism (4) of said another one of said two adjacent unit sections (1); when the two adjacent unit sections (1) are subject to circumferential pulling force, the plugging part (121) of one of said two adjacent unit sections (1) can still be stably maintained inside the inserting groove (a) of said another one of said two adjacent unit sections (1); even if two adjacent unit sections (1) are subject to lateral force, the plugging part (121) of one of said two adjacent unit sections (1) can still be maintained inside the inserting groove (a) of said another one of said two adjacent unit sections (1) due to the blocking effect by the switching mechanism (4) of said another one of said two adjacent unit sections (1), thereby ensuring a stable connection between the two adjacent unit sections (1).

Each unit section (1) comprises an outer side piece (11), an inner side piece (13), and a middle piece (12) arranged in between the outer side piece (11) and the inner side piece (13); the outer side piece (11), the inner side piece (13) and the middle piece (12) are arc-shaped structures extending along a lengthwise direction of the unit section (1), and are plastic parts made by injection molding; the outer side piece (11) and the inner side piece (13) are in locked connection through first screws (15); the outer side piece (11) and the middle piece (12) are in locked connection through a second screw (16); a positioning inserting slot (123) is formed on the middle piece (12) extending along its lengthwise direction; a positioning inserting board (114) inserted into the positioning inserting slot (123) is formed on a bottom side of the outer side piece (11); coordination between the positioning inserting slot (123) and the positioning inserting board (114) achieves accurate and reliable installation of the middle piece (12); the middle piece (12) is provided with a screw base (129) arranged in a middle part of the positioning inserting slot (123); the second screw (16) passes through the screw base (129) and connects to a screw locking hole (161) arranged within the outer side piece (11); a first cylinder (116) is formed on the outer side piece (11) at a middle part of the positioning inserting board (114); the screw locking hole (161) is formed within the first cylinder (116); a first recessed part (125) corresponding to the first cylinder (116) is formed at a middle part of the positioning inserting slot (123); the first cylinder (116) is embedded into the first recessed part (125) to achieve positioning; the screw base (129) is arranged directly below the first recessed part (125).

Two counterbores (c) are formed towards an interior of the inner side piece (13) for the first screws (15) to pass through; two counterbore bases (132) in a hollow cylindrical shape are formed on the inner side piece (13); the counterbores (c) are formed on the counterbore bases (132) respectively; second recessed parts (128) corresponding to the counterbore bases (132) are formed on a bottom side of the outer side piece (11); two second cylinders (115) corresponding to the two counterbore bases (132) are formed on a bottom side of the outer side piece (11); further screw locking holes (151) are formed within the second cylinders (115) respectively; two third recessed parts (124) arranged on both sides of the first recessed part (125) respectively are formed at the positioning inserting slot (123); the second cylinders (115) pass through the third recessed parts (124) respectively and abut against bottom surfaces of the counterbores (c) respectively; the first screws (15) pass through the counterbores (c) and are in locked connection with the further screw locking holes (151) respectively; through the corresponding embedding coordination of the recessed parts and the cylinders, a reliable connection between the outer side piece (11), the inner side piece (13) and the middle piece (12) is achieved, the efficiency and accuracy of installation are also enhanced.

An elastic massage head (14) is provided on an outer side of the inner side piece (13) facing inwardly to the hula hoop; the elastic massage head (14) is made of elastic materials, particularly rubber or silicone; a mounting hole (134) opposite to the second screw (16) is formed on said outer side of the inner side piece (13); the second screw (16) enters a corresponding unit section (1) through the mounting hole (134) and connects and locks the middle piece (12) and the outer side piece (11) together; the elastic massage head (14) is provided with a limiting part (142) fitted at an inner flange of the mounting hole (132), a massaging part (141) configured out of the mounting hole (134), and a connecting part (144) connecting the massaging part (141) and the limiting part (142); plug heads (143) are formed on the massaging part (141) inserting into the two hollow counterbore bases (132) respectively, so as to conceal the first screws (15) and the second screw (16); when the unit section (1) needs to be disassembled, just remove the elastic massage head (14) to manipulate the first screws (15) and the second screw (16); when assembling, just press the limiting part (142) into the mounting hole (134) to be fitted with the inner flange of the mounting hole (134), and by exerting a certain amount of pulling force, the limiting part (142) can be pulled and detached from the mounting hole (134), thereby disassembling the elastic massage head (14) conveniently. A top side of the limiting part (142) is provided with a deformable recess (d) which is recessed downwardly to the connecting part (144). The deformable recess (d) allows an increased degree of deformation of the limiting part (142), so that the limiting part (142) can be more easily pressed into the mounting hole (134) or detached from the mounting hole (134).

The middle piece (12) has a plate shape. One end of the middle piece (12) is connected with the plugging part (121) via a connecting board (122); another end of the middle piece (12) is provided with the inserting groove (a); the inserting groove (a) comprises the side opening (a1) and an end opening (a2). The plugging part (121), the connecting board (122), the inserting groove (a) and the middle piece (12) are formed as one integral structure. The outer side piece (11) comprises an arc-shaped main board (111), two side boards (112) connected to and extending perpendicularly from two side edges of the arc-shaped main board (111), and an end board (113) connected to and extending perpendicularly from an edge of one end of the arc-shaped main board (111). The end board (113) is provided with a cutaway portion (1131) that allows the connecting board (122) to extend outwardly through the cutaway portion (1131). The switching mechanism (4) is provided between the outer side piece (11) and the middle piece (12).

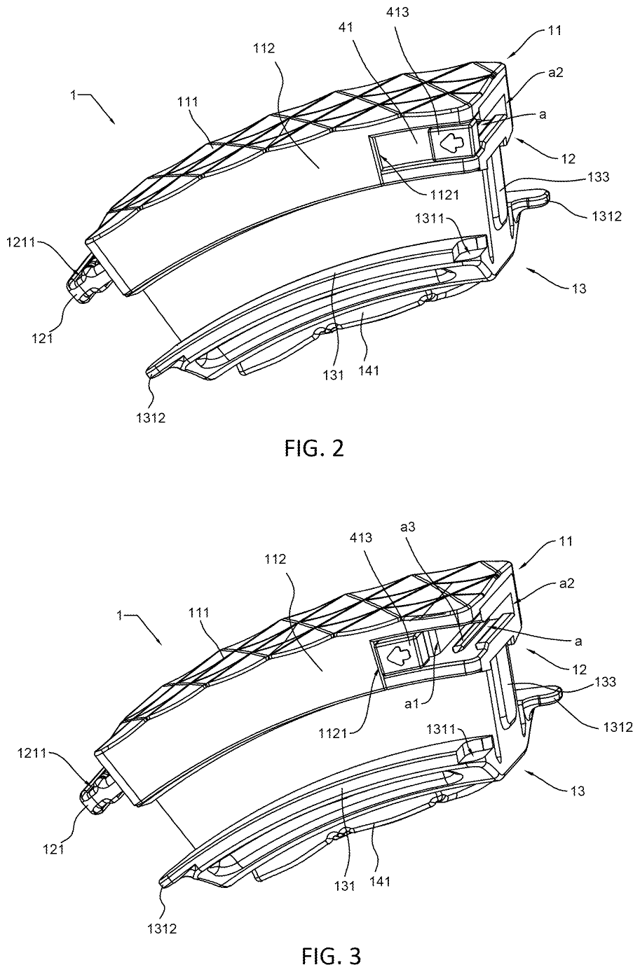

The switching mechanism (4) comprises a sliding block (41) and a spring (42). The sliding block (41) is movably provided on the unit section (1) between a close position and an open position. With reference to FIG. 2, when the sliding block (41) is positioned at the close position, the sliding block (41) blocks the side opening (a1) of the inserting groove (a). When the sliding block (41) is positioned at the open position, the sliding block (41) opens the side opening (a1) of the inserting groove (a). The spring (42) drives the sliding block (41) to bias against the close position. Specifically, the sliding block (41) is slidably disposed between a bottom surface of the arc-shaped main board (111) of the outer side piece (11) and an upper surface of the middle piece (12). An outer side of the sliding block (41) is provided with an operating portion (413). A notch (1121) allowing the operating portion (413) to slide is provided on one of the side boards (112). A protruding flange (127) corresponding to the notch (1121) protrudes out of one side of the middle piece (12). The operating portion (413) is limited to slide between the protruding flange (127) and the bottom surface of the arc-shaped main board (111). A top surface of the sliding block (41) is provided with an upper protruding rib (411) extending along a sliding direction of the sliding block (41). A bottom surface of the sliding block (42) is provided with a lower protruding rib (412) extending along the sliding direction of the sliding block (41). The bottom surface of the arc-shaped main board (1110) is provided with an upper sliding groove (116) corresponding to the upper protruding rib (411) and in which the upper protruding rib (411) slides. The upper surface of the middle piece (12) is provided with a lower sliding groove (126) corresponding to the lower protruding rib (412) and in which the lower protruding rib (412) slides. The upper protruding rib (411) and the lower protruding rib (412) extending along the sliding direction of the sliding block (41) and slidably cooperative with the upper sliding groove (116) and the lower sliding groove (126) respectively on one hand strengthen the installation of the sliding block (41) so that the sliding block (41) can withstand the lateral action force from the plugging part (121) without being damaged or falling off, and on the other hand limit the stroke of the sliding block (41). Cross sections of both the upper protruding rib (411) and the lower protruding rib (412) are rectangular.

The bottom surface of the arc-shaped main board (111) is provided with a spring groove (117). The spring (42) is mounted in the spring groove (117). One end of the sliding block (41) is provided with a positioning rod (414) that is inserted into the spring (42). The positioning rod (414) has a cross section of a cross shape. During operation, push the sliding block (41) of any one of the unit sections so that the sliding block (41) slides to the open position, and then the plugging part (121) of an adjacent unit section can be inserted into or withdrawn from the inserting groove (a) of said one of the unit sections via the side opening (a1) of said one of the unit sections. When the plugging part (121) of the adjacent unit section is inserted into the inserting groove (a) of said one of the unit sections, release the sliding block (41) of said one of the unit sections so that the sliding block (41) automatically resets to the close position under the resilient force of the spring (42) to block the side opening (a1) of the inserting groove (a), and as such, the plugging part (121) of the adjacent unit section cannot be pulled out. The present invention enables convenient operation according to which two adjacent unit sections (1) can be detached from each other even by using only one single hand when it is desired to open up the hoop body (A).

The inserting groove (a) of each unit section is provided with a positioning rib (a3) extending along an extending direction of the inserting groove (a) which extends along the widthwise direction of the corresponding unit section. The plugging part (121) of each unit section is provided with a positioning groove (1211) corresponding to the positioning rib (a3) of a respective adjacent unit section. Cooperation between the positioning rib (a3) and the positioning groove (1211) enables the plugging part (121) of each unit section to be stably maintained inside the inserting groove (a) of the respective adjacent unit section without any wobbling.

The widthwise direction of each unit section (1) along which the inserting groove (a) extends is perpendicular to a lengthwise direction of the corresponding unit section (1). Alternatively, the widthwise direction of each unit section (1) along which the inserting groove (a) extends is not perpendicular to the lengthwise direction of the corresponding unit section (1). In the former configuration, insertion of the plugging part (121) of a respective adjacent unit section can be realized more easily and smoothly so that two adjacent unit sections (1) can be connected more quickly and conveniently. In the latter configuration, the plugging part (121) of a respective adjacent unit section is difficult to be pulled out from the side opening (a1) of the inserting groove (a), so that connection between two adjacent unit sections (1) is more reliable.

The outer side of the inner side piece (13) facing inwardly to the hula hoop has two side edges of said outer side each extending transversely with an arc-shaped blocking board (131). Each arc-shaped blocking board (131) has one end disposed with a blocking portion (1312) extending along a lengthwise direction thereof, and another end disposed with an indented portion (1311) allowing insertion of another corresponding blocking portion (1312) from an adjacent unit section. An upper surface of each blocking portion (1312) aligns with an upper surface of the corresponding arc-shaped blocking board (131) on which it is disposed. The indented portion (1311) of each arc-shaped blocking board is configured such that a corresponding blocking portion (1312) of an adjacent unit section can be inserted sideway along a widthwise direction of the arc-shaped blocking board. By configuring the indented portion (1311) of each arc-shaped blocking board (131) to be inserted by a corresponding blocking portion (1312) of an adjacent unit section, each arc-shaped blocking board (131) and a corresponding arc-shaped blocking board (131) of an adjacent unit section can be reliably positioned with respect to each other. In each inner side piece (13), when one end of one of the two arc-shaped blocking boards (131) of the inner side piece (13) is provided with the blocking portion (1312), an end of another one of the two arc-shaped blocking boards (131) of the same inner side piece (13) orienting towards a same direction as said one end of said one of the two arc-shaped blocking boards (131) is provided with the indented portion (1311); accordingly, when two adjacent unit sections (1) are connected together via the plugging part (121) of one of the two adjacent unit sections and the inserting groove (a) and the side opening (a1) of another one of the two adjacent unit sections, the blocking portion (1312) and the indented portion (1311) provided respectively on two same-direction-oriented ends of the two arc-shaped blocking boards (131) of the same inner side piece (13) of one of the adjacent unit sections (1) can be fitted correspondingly with the corresponding blocking portion (1312) and the corresponding indented portion (1311) of the inner side piece (13) of another one of the adjacent unit sections (1) accurately and without interference. However, if the two arc-shaped blocking boards (131) of each inner side piece (13) have their same-direction-oriented ends both provided with either the blocking portion (1312) or the indented portion (1311) respectively, connection between two adjacent unit sections (1) from sideway through insertion of the plugging part of one of the two adjacent unit sections into the inserting groove of another one of the two adjacent unit sections via the side opening of another one of the two adjacent unit sections will result in interference that disables the blocking portions (1312) at the same-direction-oriented ends of the arc-shaped blocking boards (131) of the inner side piece (13) of one of the two adjacent unit sections to be inserted into the corresponding indented portions (1311) at the same-direction-oriented ends of the arc-shaped blocking boards (131) of the inner side piece (13) of another one of the two adjacent unit sections. Only if the two adjacent unit sections (1) are connected by other connecting mechanisms that allow the opposite end surfaces of the two adjacent unit sections (1) to be connected by bringing the opposite end surfaces oppositely towards each other instead of by inserting one of the two adjacent unit sections from sideway into another one of the two adjacent unit sections through the side opening of said another one of the two adjacent unit sections, the aforementioned problem of interference will not exist, and in this scenario, the two arc-shaped blocking boards (131) of each inner side piece (13) may have their same-direction-oriented ends both provided with either the blocking portion (1312) or the indented portion (1311) respectively.

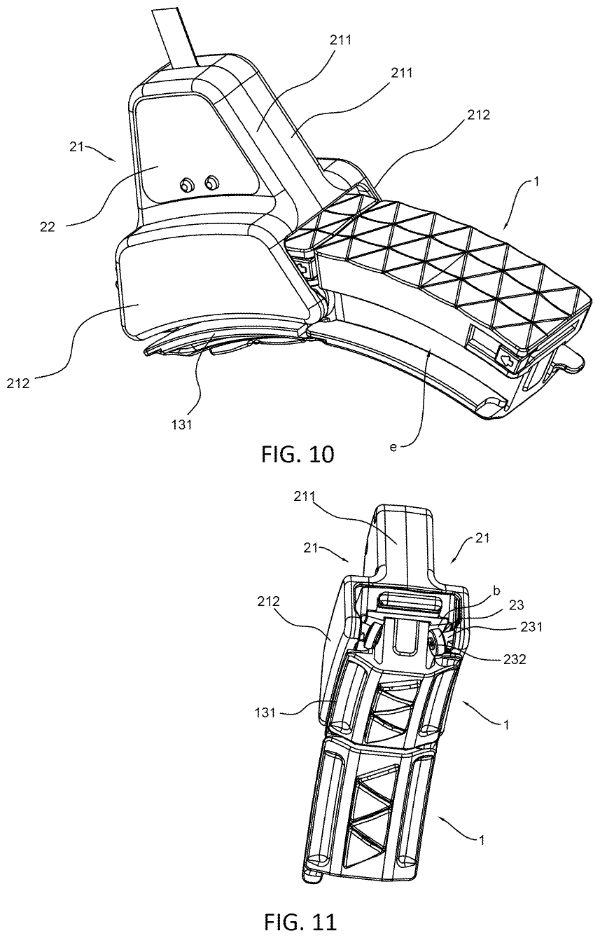

Cooperative relationship between the blocking portion (1312) of any one of the arc-shaped blocking board (131) of one of the two adjacent unit sections (1) and the indented portion (1311) of a corresponding arc-shaped blocking board (131) of another one of the two adjacent unit sections (1) may conceal the gap between the two corresponding arc-shaped blocking boards (131) of the two adjacent unit sections (1), and prevent clothes of the user from being clamped by the gap which otherwise affecting the use of the hula hoop. Nonetheless, gap may still exist between the blocking portion (1312) of any one of the arc-shaped blocking board (131) of one of the two adjacent unit sections (1) and the corresponding indented portion (1311) of a corresponding arc-shaped blocking board (131) of another one of the two adjacent unit sections (1), such that a space for deformation is reserved between the two adjacent unit sections (1) to accommodate different internal diameters of the hoop body (A). A length of the blocking portion (1312) is 3 to 8 mm. The blocking portion having the length in said range may accommodate different internal diameters of the hoop body (A), thereby ensuring reliability of the blocking effect. Two sides of a bottom surface of the middle piece (12) are each provided with an arc-shaped rail portion (b) opposite to and spaced apart from a corresponding arc-shaped blocking board (131). Each arc-shaped rail portion (b) is slidably cooperative with a corresponding wheel (23) of the sliding base (2). A trough (e) is defined between each arc-shaped rail portion (b) and the corresponding arc-shaped blocking board (131) so that the corresponding wheel (23) of the sliding base (2) is slidable therein. With reference to FIG. 10 and FIG. 11, an outer side edge of the arc-shaped blocking board (131) is positioned more outwardly from the hula hoop than an outer side edge of the corresponding arc-shaped rail portion (b), so that the arc-shaped blocking board (131) may conceal the wheel (23) and prevent clothes of users from being dragged by the wheel (23). Two end surfaces of the inner side piece (13) are each provided with a position limiting platform (133) positioned between two adjacent unit sections (1) to provide a distance between two adjacent unit sections (1) so as to prevent the distance between the two adjacent unit sections (1) becoming too small due to deformation of the hoop body (A) which may otherwise clamp the skin of the waist of the user.

The sliding base (2) comprises two shells (21) correspondingly connected with each other. Each of the two shells (21) comprises a mounting portion (211) and a side rack (212); the two mounting portions (211) of the two shells (21) connect with each other; the two side racks (212) of the two shells (21) extend down to two sides of the unit section (1) respectively; an inner side of each side rack (212) is provided with the wheel (23); each wheel (23) is configured to roll on a corresponding arc-shaped rail portion (b). With reference to FIG. 11, each wheel (23) is connected with a wheel shaft (231) via a bolt (232), and the wheel shaft (231) extends from the corresponding side rack (212) to the wheel (23) in an inclined manner away from a top side of the unit section; and a rail surface of the corresponding arc-shaped rail portion (b) also extends towards the corresponding trough (d) in an inclined manner away from the top side of the unit section, such that when the sliding base (2) slides around the hula hoop, a central point of gravity of the sliding base (20) during sliding movement can be self-attained by the sliding base (2) under centrifugal force. A counter (22) and a magnetic sensor are disposed between the two mounting portions (211). A mounting cavity (118) that accommodates a magnet is provided on the bottom side of the outer side piece (11) of any one of the unit sections of the hula hoop. When the sliding base (2) slides around the hoop body (A) circularly, the magnetic sensor may detect the position of the magnet and transmits the detected result to the counter (22). The counter (22) counts and displays the number of times a signal is received from the magnetic sensor in order to reflect the amount of exercise completed by the user.

Only the preferred embodiments of the present invention are described above, and they should not limit the different ways of implementing the present invention. Any changes and modifications that may achieve equivalent technical effects in accordance with the scope of the present invention and the disclosure in the description should also fall within the scope of the present invention.

What is claimed is:

1. Hula hoop unit sections, wherein one end of each unit section is provided with an inserting groove with a side opening, and another end of each unit section is provided with a plugging part capable of inserting into the inserting groove of an adjacent unit section through the side opening of the adjacent unit section; each unit section also comprises a switching mechanism capable of opening or closing the side opening thereof.

2. The hula hoop unit sections of claim 1, wherein the switching mechanism of each unit section comprises a sliding block and a resilient piece; the sliding block is movable on the unit section between a close position and an open position; when the sliding block is positioned at the close position, the sliding block blocks the side opening of the inserting groove; when the sliding block is positioned at the open position, the sliding block opens the side opening of the inserting groove;
the resilient piece drives the sliding block to bias against the close position.

3. The hula hoop unit sections of claim 2, wherein each unit section is provided with sliding grooves extending along a sliding direction of the sliding block; the sliding block is provided with protruding ribs slidably disposed in the sliding grooves respectively.

4. The hula hoop unit sections of claim 3, wherein a top surface of the sliding block is provided with an upper protruding rib of the protruding ribs extending along a sliding direction of the sliding block; a bottom surface of the sliding block is provided with a lower protruding rib of the protruding ribs extending along the sliding direction of the sliding block; the sliding grooves comprise an upper sliding groove and a lower sliding groove corresponding to the upper protruding rib and the lower protruding rib respectively.

5. The hula hoop unit sections of claim 2, wherein an outer side of the sliding block is provided with an operating portion.

6. The hula hoop unit sections of claim 2, wherein the resilient piece is a coil spring.

7. The hula hoop unit sections of claim 6, wherein one end of the sliding block is provided with a positioning rod that is inserted into the coil spring.

8. The hula hoop unit sections of claim 1, wherein the plugging part is provided on each unit section via a connecting board; said one end of each unit section is also provided with an end opening in communication with the inserting groove in order to accommodate the connecting board of an adjacent unit section connected to the unit section via the inserting groove of the unit section.

9. The hula hoop unit sections of claim 1, wherein the inserting groove of each unit section is provided with a positioning rib extending along an extending direction of the inserting groove; the plugging part of each unit section is provided with a positioning groove corresponding to the positioning rib of the first adjacent unit section.

10. The hula hoop unit sections of claim 1, wherein in each unit section, the inserting groove extends along a widthwise direction of the unit section.

11. The hula hoop unit sections of claim 10, wherein the inserting groove extends along the widthwise direction of the unit section perpendicularly to a lengthwise direction of the unit section.

12. The hula hoop unit sections of claim 10, wherein the inserting groove extends along the widthwise direction of the unit section but not perpendicular to a lengthwise direction of the unit section.

13. The hula hoop unit sections of claim 1, wherein each unit section has an arc shape; an outer side surface of each unit section facing inwardly to a hula hoop configured after all unit sections are assembled, has two side edges each extending transversely with an arc-shaped blocking board, so that there are two arc-shaped blocking boards in each unit section; each arc-shaped blocking board has one end disposed with a protruding blocking portion, and another end disposed with an indented portion allowing insertion of another corresponding blocking portion from a corresponding adjacent unit section; in each unit section, when one end of one of the two arc-shaped blocking boards is provided with the blocking portion, an end of another one of the two arc-shaped blocking boards orienting towards a same direction as said one end of said one of the two arc-shaped blocking boards is provided with the indented portion.

14. The hula hoop unit sections of claim 13, wherein two sides of each unit section are each provided with an arc-shaped rail portion opposite to and spaced apart from a corresponding arc-shaped blocking board, so that each unit section has two arc-shaped rail portions.

15. The hula hoop unit sections of claim 14, wherein an outer side edge of each arc-shaped blocking board is positioned more outwardly from the hula hoop than an outer side edge of the corresponding arc-shaped rail portion.

16. The hula hoop unit sections of claim 2, wherein each unit section comprises an outer side piece, an inner side piece, and a middle piece arranged in between the outer side piece and the inner side piece; one end of the middle piece is connected with the plugging part; another end of the middle piece is provided with the inserting groove; the sliding block is slidable between the outer side piece and the middle piece.

17. The hula hoop unit sections of claim 16, wherein a positioning inserting slot is formed on the middle piece extending along a lengthwise direction of the middle piece; a positioning inserting board inserted into the positioning inserting slot is formed on a bottom side of the outer side piece.

18. The hula hoop unit sections of claim 16, wherein the outer side piece and the inner side piece are in locked connection through first screws; two counterbores are formed towards an interior of the inner side piece for the first screws to pass through; the outer side piece and the middle piece are in locked connection through a second screw.

19. The hula hoop unit sections of claim 18, wherein an elastic massage head is provided on an outer side of the inner side piece facing inwardly to a hula hoop configured after all unit sections are assembled; a mounting hole is formed on said outer side of the inner side piece to accommodate the elastic massage head; the second screw is placed into the unit section through the mounting hole before installing the elastic massage head, to connect and lock the middle piece and the outer side piece together; the elastic massage head is provided with a limiting part fitted at an inner flange of the mounting hole, a massaging part configured out of the mounting hole, and a connecting part disposed between the massaging part and the limiting part to connect the massaging part and the limiting part; plug heads are formed on the massaging part inserting into two hollow counterbore bases of the counterbores respectively.

20. The hula hoop unit sections of claim 19, wherein a top side of the limiting part is provided with a deformable recess which is recessed downwardly to the connecting part.

21. The hula hoop unit sections of claim 1, wherein two end surfaces of each unit section are each provided with a position limiting platform.

22. A hula hoop, comprising a hoop body, a sliding base, and a counterweight piece; the sliding base is slidably arranged onto the hoop body; the counterweight piece is connected to the sliding base; wherein the hoop body is formed by connecting a plurality of unit sections of claim 1 end to end; each unit section has an arc shape; every two adjacent unit sections are detachably connected via the plugging part of one of the two adjacent unit sections inserting into the inserting groove of another one of the two adjacent unit sections.

23. The hula hoop of claim 22, wherein an outer side surface of each unit section facing inwardly to the hula hoop configured after all unit sections are connected, has two side edges each extending transversely with an arc-shaped blocking board, so that there are two arc-shaped blocking boards in each unit section; each arc-shaped blocking board has one end disposed with a protruding blocking portion, and another end disposed with an indented portion allowing insertion of another corresponding blocking portion from a corresponding adjacent unit section; in each unit section, when one end of one of the two arc-shaped blocking boards is provided with the blocking portion, an end of another one of the two arc-shaped blocking boards orienting towards a same direction as said one end of said one of the two arc-shaped blocking boards is provided with the indented portion; a gap exists between the blocking portion of any one of the arc-shaped blocking board of one of the two adjacent unit sections and the corresponding indented portion of a corresponding arc-shaped blocking board of another one of the two adjacent unit sections.

24. The hula hoop of claim 23, wherein a length of each blocking portion is 3 to 8 mm.
